(19) United States
(12) Patent Application Publication
(10) Pub. No.: US 2007/0168520 A1
(43) Pub. Date: Jul. 19, 2007

(54) Network layer end-point transfer

(75) Inventors: Gregory Michael Perkins, Pennington, NJ (US); Sathya Narayanan, Princeton, NJ (US); David Alan Braun, Denville, NJ (US); Daisaku Komiya, Kanagawa (JP)

Correspondence Address: RATNERPRESTIA, P.O. BOX 980, VALLEY FORGE, PA, 19482, US

(73) Assignee: Matsushita Electric Industrial Co., Ltd.

(21) Appl. No.: 11/332,661

(22) Filed: Jan. 13, 2006

(51) Int. Cl. G06F 15/16

(52) U.S. Cl. 709/227

(57) ABSTRACT

Methods and apparatus for handing off an end-point associated with a first device to a second device within a locally accessible network operating in an Internet protocol (IP) environment that supports multiple addresses for each device are provided. The first device is in a currently established session with a third device within the IP environment. End-point information associated with the end-point of the first device is locally transferred to the second device. A further end-point, compatible with the currently established session, is configured by the second device using the transferred end-point information. The second device broadcasts an announcement to the locally accessible network, including the router, that the second device is associated with the further end-point.

### FIELD OF THE INVENTION

The present invention concerns locally accessible networks and in particular a method for handing off end-point information between devices in a locally accessible network.

### BACKGROUND OF THE INVENTION

A wide variety of devices may be incorporated in a locally accessible network (herein local network), such as a personal area network (PAN). The local network may be a wired or wireless network or a combination of both wired and wireless networks. Each device is associated with an end-host. Internet Protocol (IP) packets from a device outside of the network are routed to the end-host of the device within the local network, forming a communication channel between these devices. An end-host is defined herein as the node on the network to which the device is in communication.

Addressing and packet routing schemes in IP provide routing of IP packets between devices in a local network and outside devices operating in a global network, i.e. the Internet. One such scheme is IPv6, where addressing and routing support are described in Internet Request for Comments (RFC) 2373 by R. Hinden and S. Deering entitled “IP Version 6 Addressing Architecture” and neighbor discovery is described in (RFC) 2461 by T. Narten, E. Nordmark and W. Simpson entitled “Neighbor Discovery for IPv6,” 1998. In IPv6, a large number of IPv6 addresses are available for use. The IPv6 addresses may be associated with individual sessions and multiple IPv6 addresses may be located in a single end host. The neighbor discovery (ND) protocol permits devices to discover other nodes on the link and allows devices to create IPv6 addresses.

In the ND protocol, a neighbor solicitation message may be sent by a device to determine the link-layer address of a neighbor. A neighbor advertisement message may be sent in response to the neighbor solicitation message. The neighbor advertisement message may also be used to announce a link-layer address change by a device.

Typically, to hand-off a session from a first device in communication with an outside device, i.e. a remote party, to a second device, the first and possibly second device each contact the outside device in order to perform the end-point handoff. This procedure is typically used because a new IP address is often needed by the second device. New security associations (SAs) may also be needed by the second device. It may be desirable, however, to provide a local session transfer without contacting the remote party.

### SUMMARY OF THE INVENTION

The present invention is embodied in a method for handing off an end-point associated with a first device to a second device. The first and second devices are within a locally accessible network. The locally accessible network operates in an Internet protocol (IP) environment. The IP environment of each device is configured to store multiple IP addresses. The first device is in a currently established session with a third device within the IP environment via a router. The method includes locally transferring end-point information associated with the end-point of the first device to the second device within the locally accessible network. The method configures a further end-point by the second device using the transferred end-point information. The further end-point is compatible with the currently established session. The method further broadcasts, by the second device, an announcement to the locally accessible network, including the router, that the second device is associated with the further end-point.

The present invention is further embodied in a method for handing-off an end-point associated with a first device to a second device. The first and second devices are within a locally accessible network. The locally accessible network operates in an Internet protocol (IP) environment that supports multiple IP addresses for each device. The first device is in a currently established session with a third device within the IP environment via a router. The method includes transmitting an initialization message from the first device to the second device to condition the second device to receive end-point information associated with the end-point. The method also transmits an end-point message from the first device to the second device, the end-point message including the end-point information associated with the first device. The method configures a further end-point by the second device using the transferred end-point information. The further end-point is compatible with the currently established session. The method also broadcasts an advertisement message to the locally accessible network including to the router to announce hand-off of the end-point.

### BRIEF DESCRIPTION OF THE DRAWINGS

The invention is best understood from the following detailed description when read in connection with the accompanying drawing. Included in the drawing are the following figures:

FIG. 1 is a functional block diagram illustrating communication between local network devices for locally transferring end-point information by performing an exemplary method of the present invention;

FIG. 2 is a functional block diagram illustrating IP packet routing from an outside device to a local network device after performing end-point hand-off according to an exemplary method of the present invention;

FIG. 3 is a flow chart illustrating an exemplary method for locally handing off an end-point associated with a first device to a second device according to an aspect of the present invention; and

FIG. 4 is a flow chart illustrating an exemplary method for messaging between a first device and a second device within a local network to provide local transfer of end-point information from the first device to the second device according to an aspect of the present invention.

### DETAILED DESCRIPTION OF THE INVENTION

The present invention is embodied in a method for handing-off an end-point from a first device to a second device, where the first and second devices are within a local network. An end-point is defined herein as including an IP address as well as any security associations and/or other Open Systems Interconnection (OSI) network layer information to be transferred from the first device to the second device. The first device may be in communication with an outside device through a global network, e.g. the Internet, via a router. In an exemplary embodiment, the first and second device perform a local messaging procedure to transfer end-point information from the first device to the second device, without involving the third device. After the second device broadcasts a neighbor advertisement message, the router may route IP packets from the third device, that are designated for the transferred end point to the second device within the local network.

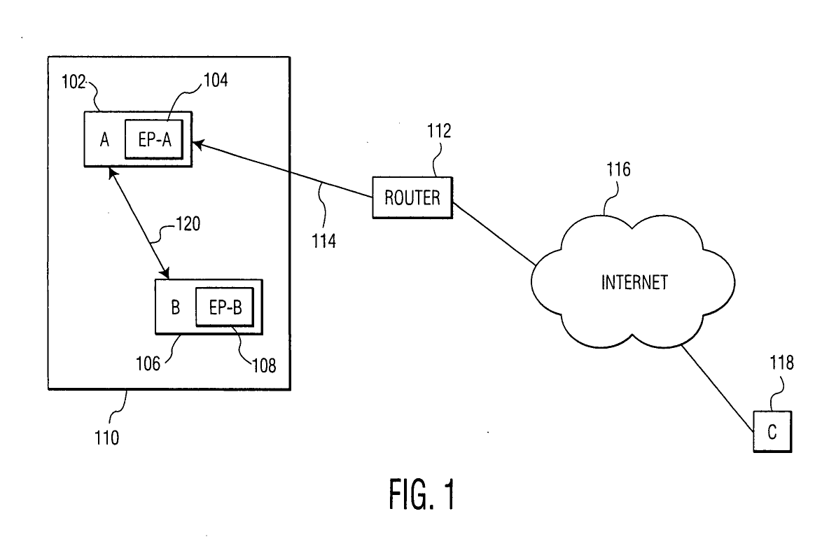

FIG. 1 is a functional block diagram showing localized transfer of end-point information according to an exemplary method of the present invention. Device A 102 having an end-point 104 is in currently established session with device C 118 through the Internet 116 via router 112. Device A 102 is within local network 110. A communication channel 114 between device A 102 and router 112 is illustrated as being a direct connection. It is understood, however, that communication channel 116 may include one or more intermediate nodes. Local network also includes a device B 106 having end-point 108.

Local network 110 may be any local network such as a local area network (LAN) including an ad-hoc network, a personal area network (PAN) or a multihorned network. Each of the devices, i.e. device A 102, device B 106 and device C 118, may be any Internet-accessible device, including mobile devices such as a cellular phone, a PDA or a laptop computer.

The exemplary IP environment desirably allows each device to store multiple IP addresses. In the exemplary embodiment, described below, the IP environment is Internet protocol version 6 (IPv6) RFC 2460. IPv6 is described in RFC 2460 by S. Deering and R. Hinden entitled “Internet Protocol, Version 6,” 1998. The IP environment may support Internet Protocol security (IPsec). IPsec is described in RFC 2401 by S. Kent and S. Atkinson entitled “Security Architecture for the Internet Protocol,” 1998.

Local network 110 desirably supports a protocol that allows devices within the network to discover each other's presence and maintain reachability information to each other. In an exemplary embodiment, local network 110 supports the ND protocol. Alternatively, local network 110 may support the secure neighbor discovery (SEND) protocol. SEND is described in RFC 3971 by J. Arkko, Ed., J. Kempf, B. Zill and P. Nikander entitled “SEcure Neighbor Discovery (SEND),” 2005.

End-points 104 and 108 are desirably OSI network layer associations. Each end-point 104 and 108 includes an associated IP address. Each end-point may also include security associations (SAs) between the respective device and a communicating device, i.e. device C 118. For example, end-point 104 of device A 102 may include associated SAs between device A 102 and device C 118. Although only one end-point is illustrated as being associated with each of devices A 102 and B 106, it is understood that each device may include multiple end-points. This is due to the ability of each device to store multiple IP addresses. Each end-point may thus be associated with a different IP address, for example, IP addresses for different sessions.

It is desirable to hand-off end-point 104 from device A 102 to device B 106 without losing communication with device C 118. For example, device A 102 may be a PDA receiving a video stream from device C 118. Device A 102 may be near device B 106 which is a digital television and it is desired to hand off the video stream from the PDA, device A 102, to the digital television, device B 106, without losing communication with device C 118.

According to an exemplary embodiment of the present invention, device A 102 contacts device B 106 to initiate an end-point hand-off protocol. Direct communication between device A 102 and device B-106 is illustrated by messaging 120. Messaging 120 is desirably a messaging path between device A 102 and device B 106 to initiate hand-off of end-point 104 to device B 106. Each device desirably supports the ND protocol or the SEND protocol. Each device is therefore aware of neighboring devices within local network 110. Because device A 102 and device B 106 are aware of their respective local addresses, it is possible for them to directly communicate with each other without involving router 112, Internet 116, device 118. According to the exemplary embodiment of the present invention, end-point hand-off, as described below, is thus a local transmission process.

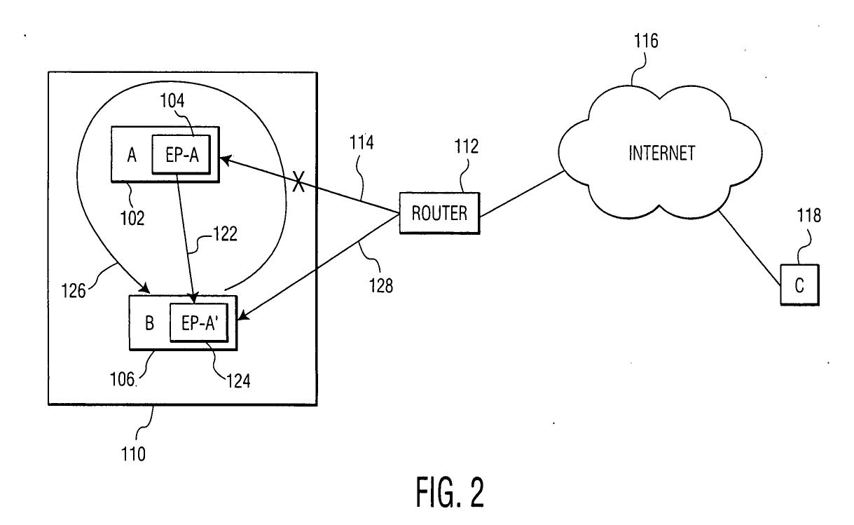

FIG. 2 is a functional block diagram showing IP packet routing from an outside device, i.e. device C 118, to a local network device, i.e. device B 106, after performing end-point hand-off according to an exemplary method of the present invention. Messaging 120 (FIG. 1) between device A 102 and device B 106 establishes the hand-off of end-point 104. Information about end-point 104 is then transmitted to device 106, illustrated by message 122. The IP address, as well as any SAs between device A 102 and device C 118 may be transferred to device B 106. It is contemplated that device B 106 may also include other IP addresses and associated SAs between device B 106 and other devices (not shown). Device B 106 may store information about end-point 104, for example, in a table internal to device B 106. Information about end-point 104 may be used to configure end-point 124 to be compatible with the currently established session.

Device B 106 may then broadcast a neighbor advertisement message 126 to local network 110 and router 112 that device B 106 is associated with end-point 124 (which is configured to be compatible with the currently established session). Device A 102 desirably releases end-point 104 and does not contest message 126.

Upon receipt of message 126, router 112 routes IP packets from device C 118, originally destined for device A 102, to device B 106. Communication channel 114 to device A 102 is no longer active and IP packets are directed through communication channel 128 to device B 106. Device C 118 is desirably unaware of the hand-off procedure at the network layer. The present invention may thus keep communication channel information secure within local network 110. The features of the ND protocol or the SEND protocol and IPv6 may allow an exemplary method of the present invention to be performed without disruptions at the network layer.

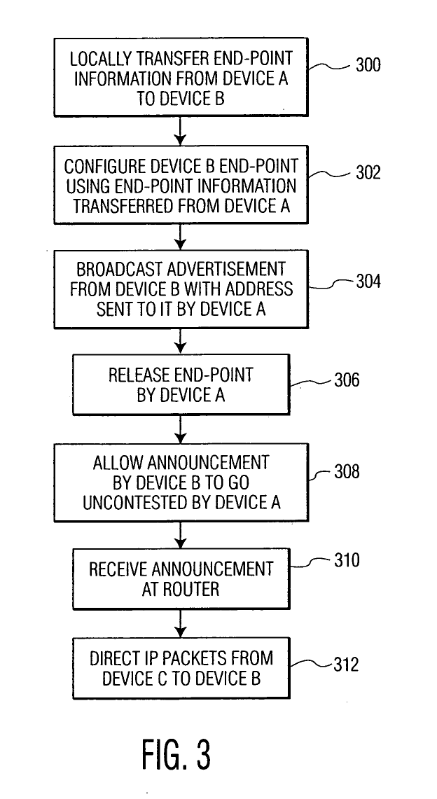

FIG. 3 is a flow chart illustrating an exemplary method for locally handing off an end-point associated with a first device, i.e. device A 102, to a second device, i.e. device B 106, according to an aspect of the present invention. It is assumed that device A 102 is in a currently established session with device C 118. In step 300, end-point information 104 from device A 102 is locally transferred to device B 106. This may involve messaging between devices 102 and 106 to initiate end-point hand-off as well as transferring the end-point information. Each device may include a processor that performs a messaging protocol to initiate end-point hand-off and transferring the end-point information. It is contemplated that the end-point information may be transferred within the OSI transport layer.

It is contemplated that each device, using the ND protocol or the SEND protocol, is aware of IP addresses associated with other devices in the local network. Each device may include a memory to store IP addresses of neighbors in a neighbor table, for example. Each device may further store IP addresses related to different sessions in a session table. Each device may periodically broadcast neighbor solicitation messages and receive solicited neighbor advertisement messages with which to update its neighbor and session tables. Each device may further receive unsolicited neighbor advertisement messages when an IP address associated with a device has changed.

Step 300, locally transfers end-point information. This may be performed in a secure manner, for example using IPsec. An upper layer method, such as a cryptographic method (e.g. pretty good privacy (PGP), advanced encryption standard (AES), data encryption standard (DES), triple DES or Diffie-Hellman key exchange) operating at the OSI session layer may also provide a secure transfer. Security may not be needed if the SAs are current or the local network is considered trustworthy. If the SAs are old or if the local network is not considered secure, i.e. a wireless LAN with no channel security), it may be desirable to perform a secure hand-off.

In step 302, the end-point 124 of device B 106 is configured using the end-point information transferred from device A 102. Device B 106 may use the IP address of device A 102 as well as any SAs of device A 102 with respect to device C 118 to configure its end-point 124 to be compatible with the currently established session.

In step 304, device B 106 broadcasts an unsolicited neighbor advertisement message to local network 110 announcing that it is associated with the IP address received from device A 102. It is desirable that an override flag is set to 1 in an Internet control message protocol (ICMP) field of the neighbor advertisement message header. Setting the override flag indicates that the advertisement should override an existing cache entry and update the cached link-layer address. The router may verify and update its associations with ND and/or SEND. It is contemplated that steps 302 and 304 may be performed concurrently.

In step 306, end-point 104 is released by device A 102. In step 308, device A 102 allows the neighbor advertisement announcement by device B 106 to go uncontested. According to an embodiment of the present invention, a pre-agreement to transfer the IP address of device A 102 to device B 106 is not required. It is contemplated that, if device A 102 desires to protect its address, the SEND protocol may be used instead of the ND protocol. It is contemplated that steps 306 and 308 may be performed concurrently.

In step 310, router 112 receives the announcement. In step 312, the router directs IP packets from device C 118, that had previously been sent to device A 102, to device B 106. Because device B 106 includes the SAs from device A 102 with respect to device C 118, device B 106 may perform all IPsec related security protocols between itself and device C 118. Device C 118, thus may not be aware that a hand-off has occurred.

As described above, each device includes a processor which allows each device to perform the above exemplary end-point hand-off method. Each device, for example, may include an end-point hand-off protocol that allows the processor of the device to perform the method described by steps 302, 304, 306 and 308. A router may similarly include a processor and a protocol for routing IP packets according to an exemplary method of the present invention.

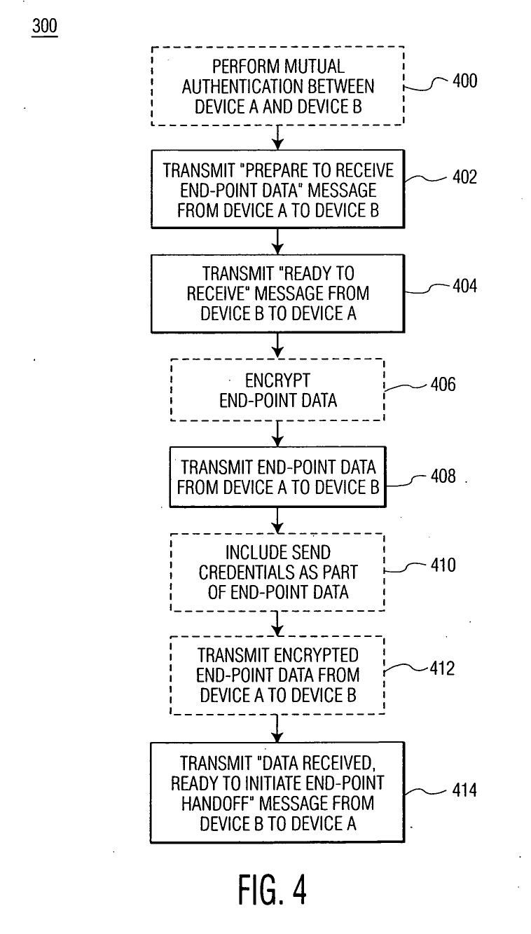

FIG. 4 is a flow chart illustrating an exemplary method for messaging between a first device, e.g. device A 102, and a second device, e.g. device B 106, within a local network to provide local transfer of end-point information, step 300 (FIG. 3) according to an aspect of the present invention. It is contemplated that the messaging procedure between device A 102 and device B 106 may be encrypted. Prior to initiating a secure hand-off, it is contemplated that devices A and B have setup IPsec security associations and that device A 102 is in a currently established session with device C 118. In alternate step 400, a mutual authentication is performed between device A and device B to initiate a secure hand-off.

In step 402, a message is sent from device A 102 to device B 106 for device B 106 to prepare to receive end-point data. In step 404, a message is sent from device B 106, responsive to the message sent by device A 102 in step 402, that device B 106 is ready to receive data from device A 102. It is contemplated that the messages of steps 402 and 404 may be transmitted between device A 102 and device B 106 as one initialization message to condition device B 106 to receive end-point information.

In alternate step 406, end-point information to be sent from device A 102 may be encrypted. For example, if a secure hand-off is desired, IPsec Encapsulated Security Protocol (ESP) or an upper layer cryptographic process may be used to encrypt the information.

In step 408, the end-point information is transmitted from device A 102 to device B 106. The end-point information may be sent responsive to the message, step 404, that device B 106 is ready to receive the end-point information. In alternate step 410, which may be performed if the local network supports the SEND protocol, SEND credentials are included with the end-point information transmitted from device A 102. In further alternate step 412, which may be performed if the data is encrypted, step 406, encrypted end-point information is transmitted from device A 102 to device B 106.

In step 414, device B 106 transmits an acknowledgement message indicating that the data is received and that it is ready to initiate hand-off of the end-point from device A 102. It is contemplated that steps 414 and 408 may be transmitted between device A 102 and device B 106 as one end-point message. The end-point message may further include alternate step 408 and/or alternate steps 406 and 412.

Although the invention has been described as apparatus and a method, it is contemplated that it may be practiced by computer program instructions embodied in a computer-readable carrier such as an integrated circuit, a memory card, a magnetic or optical disk or an audio-frequency, radio-frequency or optical carrier wave.

Although the invention is illustrated and described herein with reference to specific embodiments, the invention is not intended to be limited to the details shown. Rather, various modifications may be made in the details within the scope and range of equivalents of the claims and without departing from the invention.

While preferred embodiments of the invention have been shown and described herein, it will be understood that such embodiments are provided by way of example only. Numerous variations, changes and substitutions will occur to those skilled in the art without departing from the spirit of the invention. Accordingly, it is intended that the appended claims cover all such variations as fall within the spirit and scope of the invention.

What is claimed:

1. A method for handing off an end-point associated with a first device to a second device, the first and second devices being within a locally accessible network, the locally accessible network operating in an Internet protocol (IP) environment, the IP environment of each device being configured to store multiple IP addresses, the first device being in a currently established session with a third device within the IP environment via a router, the method comprising:
locally transferring end-point information including an IP address associated with the end-point of the first device to the second device within the locally accessible network;
configuring a further end-point by the second device using the transferred end-point information, the further end-point being compatible with the currently established session; and
broadcasting, by the second device, an announcement to the locally accessible network, including the router, that the second device is associated with the further end-point,
whereby the router receives the announcement and redirects IP packets from the third device previously associated with the end-point associated with the first device to the further end-point associated with second device.

2. The method according to claim 1, wherein the step of locally transferring the end-point information includes the step of releasing the end-point by the first device.

3. The method according to claim 1, wherein the step of broadcasting the announcement includes the step of, in the first device, allowing the announcement to go uncontested.

4. The method according to claim 1, wherein the step of locally transferring the end-point information includes the steps of:
encrypting the end-point information in the first device;
transferring the encrypted end-point information from the first device to the second device; and
decrypting the encrypted end-point information in the second device.

5. The method according to claim 1, wherein the IP environment is Internet Protocol version 6 (IPv6) and the step of broadcasting the announcement includes the step of setting an override flag to 1 in an Internet control message protocol (ICMP) field of a header of the announcement.

6. The method according to claim 5, wherein the end-point information includes an IP address of the first device and the step of locally transferring the end-point information transfers the IP address of the first device to the second device, the second device storing the IP address of the first device among one or more IP addresses associated with the second device.

7. The method according to claim 6, wherein the end-point information further includes security associations (SAs) between the first device and the third device and the step of locally transferring the end-point information transfers the SAs to the second device, the second device storing the SAs.

8. A computer readable carrier including a computer instructions that cause a computer to perform the method according to claim 1.

9. A method for handing-off an end-point associated with a first device to a second device, the first and second devices being within a locally accessible network, the locally accessible network operating in an Internet protocol (IP) environment, the IP environment supporting multiple IP addresses for each device, the first device being in a currently established session with a third device within the IP environment via a router, the method comprising:
transmitting an initialization message from the first device to the second device to condition the second device to receive end-point information associated with the end-point;
transmitting an end-point message from the first device to the second device, the end-point message including the end-point information associated with the first device, the end-point information includes an IP address;
configuring a further end-point by the second device using the transferred end-point information, the further end-point being compatible with the currently established session; and
broadcasting an advertisement message to the locally accessible network including to the router to announce hand-off of the end-point,
whereby IP packets from the third device to the first device are redirected by the router to the second device.

10. The method according to claim 9, the method including the step of performing a mutual authentication between the first device and the second device before the step of transmitting the message to cause the end-point information to be transferred.

11. The method according to claim 9, wherein the locally accessible network supports secure neighbor discovery (SEND) and the step of transmitting the end-point message includes transmitting the end-point information including SEND credentials associated with the first device.

12. The method according to claim 9, wherein the end-point information includes an IP address of the first device and the step of transmitting the end-point message transmits the IP address of the first device to the second device, the second device storing the IP address of the first device.

13. The method according to claim 12, wherein the end-point information further includes security associations (SAs) between the first device and the third device, and the step of transmitting the end-point message transmits the SAs to the second device, the second device storing the SAs among one or more SAs associated with the second device.

14. The method according to claim 9, wherein the step of transmitting the end-point message includes the steps of:
encrypting the end-point information in the first device;
transmitting the encrypted end-point information to the second device; and
decrypting the encrypted end-point information in the second device.

15. The method according to claim 14, wherein the end-point information is encrypted using Encapsulated Security Protocol (ESP).

16. The method according to claim 9, wherein the step of transmitting the initialization message includes the steps of:
transmitting a message from the first device to the second device to prepare to receive data; and
transmitting a message from the second device to the first device, responsive to receiving the message from the first device, that the second device is ready to receive the data.

17. The method according to claim 16, wherein the step of transmitting the end-point message includes the steps of:
transmitting the end-point information from the first device to the second device responsive to the first device receiving the message that the second device is ready to receive the data; and
transmitting an acknowledgement message from the second device to the first device, responsive to the second device receiving the end-point data, that the data is received.

18. The method according to claim 17, wherein the step of broadcasting the advertisement includes the step of broadcasting the advertisement after the acknowledgement message is transmitted to the first device.

19. A computer readable carrier including a computer instructions that cause a computer to perform the method according to claim 9.

20. Apparatus for handing off an end-point associated with a first device to a second device, the first and second devices being within a locally accessible network, the locally accessible network operating in an Internet protocol (IP) environment, the IP environment supporting multiple IP addresses for each device, the first device being in a currently established session with a third device within the IP environment via a router, the apparatus comprising:
means for locally transferring end-point information including an IP address associated with the end-point of the first device to the second device within the locally accessible network;
means for configuring a further end-point by the second device using the transferred end-point information, the further end-point being compatible with the currently established session; and
means for broadcasting, by the second device, an announcement to the locally accessible network, including the router, that the second device is associated with the further end-point,
whereby the router receives the announcement and redirects IP packets from the third device previously associated with the end-point associated with the first device to the further end-point associated with second device.

21. Apparatus according to claim 20, wherein the end-point information includes an IP address of the first device.

22. Apparatus according to claim 20, wherein the end-point information includes an IP address of the first device and security associations (SAs) between the first device and the third device.

23. Apparatus according to claim 20, wherein the locally accessible network includes at least one of a local area network (LAN), an ad-hoc network, a personal area network (PAN) or a multi-home network.

24. Apparatus according to claim 20, wherein the locally accessible network supports at least one of neighbor discovery (ND) or secure neighbor discovery (SEND).

25. Apparatus according to claim 20, wherein the IP environment includes Internet Protocol version 6 (IPv6).

26. Apparatus according to claim 25, wherein the IP environment further includes Internet protocol security (IPsec).
